(19) United States
(12) Patent Application Publication
(10) Pub. No.: US 2009/0172581 A1
(43) Pub. Date: Jul. 2, 2009

(54) SYSTEM, METHOD AND APPARATUS FOR MULTIPLE FIELD PASTING

(75) Inventors: Marc J. Burling, Largo, FL (US); Matthew A. Stertz, Oldsmar, FL (US)

Correspondence Address: LARSON AND LARSON, 11199 69TH STREET NORTH, LARGO, FL, 33773, US

(73) Assignee: ERIE PROCESSING CORPORATION, Largo, FL (US)

(21) Appl. No.: 11/968,498

(22) Filed: Jan. 2, 2008

(51) Int. Cl. G06F 3/048

(52) U.S. Cl. 715/770

(57) ABSTRACT

An application for a method of copy and paste of multiple fields concurrently includes copying a number of fields onto a clipboard then pasting the fields from the clipboard into an insertion box of a data input screen. The data input screen also has a plurality of target data fields. The fields are parsed from the insertion box into individual data segments and the target data fields are populated with the individual data segments.

### CROSS-REFERENCE TO RELATED APPLICATION

This application is related to U.S. application titled, “System, Method and Apparatus for Gathering Student Loan Information,” which was filed on even date herewith; attorney docket number 2425.0 and inventors Marc J. Burling and Matthew A. Stertz.

### FIELD OF THE INVENTION

This invention relates to the field of cutting (copying) and pasting and more particularly to a system for copying multiple data fields and pasting the data into multiple target fields.

### BACKGROUND OF THE INVENTION

Cut and Paste operations are routine to many computer users. A selection of information is made on one set of text and/or images, the copy function is executed, a destination location is selected and the paste function is executed, copying all of the selected text and/or images into the destination location.

Shortcuts are available to reduce the amount of time required to perform such operations. For example, on some computer systems, to execute the copy function, one holds the control key (Ctrl) while pressing the ‘C’ key (abbreviated Ctrl-C). Similarly, to paste, one holds the control key (Ctrl) while pressing the ‘V’ key (abbreviated Ctrl-V). There are also shortcuts for selecting text. For example, holding the control key (Ctrl) while pressing the ‘A’ key (abbreviated Ctrl-A) selects all the text on a page or in a document, etc, also known as “highlight all.”

Many systems or data entry applications exist in which data from one system must be copied into data entry screens of another. For example, one might find themselves cutting paragraphs from their resume and pasting the cut paragraphs into an online employment web site. Another example is a loan application. In such, the applicant needs to supply prior loan data to complete an application. Instead of typing long loan numbers and details regarding each existing loan, the applicant might choose to copy and paste such information from existing loan data web pages into a loan application web page. Because the existing loan data web pages have independent fields for loan numbers, loan amounts, etc., the applicant will find they are copying and pasting small amounts of data at a time, going back and fourth between the existing loan web pages and the loan application page many times. Additionally, because it is easy to select an incorrect amount of data (e.g., a selection excludes one digit), this method is prone to errors.

It would be easier for such users to cut large sections of source data and paste them into the destination page, but no such system exists. U.S. Pat. No. 6,944,821 to Bates, et al, describes an annotated paste buffer with a first field for copied information and a second field for source information relating to the copied information. A copy/paste mechanism copies the user selected information into the first field and gathers the appropriate information relating to the source of the copied information into the second field in the annotated paste buffer. It does not provide for actively selecting information from the copied information and pasting that information into organized target fields.

Other patents describe methods of authoring a web page by selecting and cutting from other web pages and pasting on a new web page, but they do not provide for actively selecting information from the copied information and pasting that information into differently organized target fields as well.

What is needed is a system that will accept a copy buffer containing multiple fields of information, parse the copy buffer into independent data and paste each independent data into target fields of a data entry screen.

### SUMMARY OF THE INVENTION

In one embodiment, a method of copy and paste of multiple fields concurrently is disclosed including copying a number of fields onto a clipboard then pasting the fields from the clipboard into an insertion box of a data input screen. The data input screen also has a plurality of target data fields. The fields are parsed from the insertion box into individual data segments and the target data fields are populated with the individual data segments.

In another embodiment, a system copying and pasting of multiple fields concurrently is disclosed including a server computer that presents a data entry screen that has an insertion box for accepting data from a clip board and target data fields. A parser is provided to parse data from the data entry screen into individual field values and to populate the target data fields with the individual field values. The data is pasted into the at least one insertion box and the data includes more information than the plurality of target data fields.

In another embodiment, a signal tangibly embodied in a propagation medium comprising at least one instruction configured to implement a system for copying and pasting of multiple fields concurrently is disclosed wherein the at least one instruction includes computer readable instructions for presenting a data entry screen having an insertion box for accepting data from a clip board and plurality of target data fields. Computer readable instructions are provided for parsing data from the data entry screen into individual field values and for populating at the target data fields with the individual field values. The data is from a paste operation into the insertion box and the data includes more information than the plurality of target data fields.

In another embodiment, a computer-based system for copying and pasting of multiple fields concurrently is disclosed including a first and second server computer and a client computer in network communications with the first server and with the second server. The client computer runs software modules for accessing the first server and accessing the second server such as a browser. Software running on the first server computer presents data at the client computer. Software running on the second server presents a data input screen at the client computer. The data input screen includes an insertion box and target data fields. Software running on the client computer provides for copying the data from the first server onto a clipboard and for pasting the data from the clipboard into the insertion box on the data input screen. Software running on the second server computer parses the data from the insertion box into individual field values and stores the individual field values in the target data fields. The data includes more information than needed in the target data fields.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a block diagram of a system of the present invention.

FIG. 2 illustrates a block diagram showing an example data flow of the present invention.

FIG. 3 illustrates a typical loan consolidation user interface of the present invention.

FIG. 4 illustrates a typical login user interface of the present invention.

FIG. 5 illustrates a typical information gathering user interface of the present invention.

FIG. 6 illustrates a typical borrower information gathering user interface of the present invention.

FIG. 7 illustrates a typical employer information gathering user interface of the present invention.

FIG. 8 illustrates a typical references gathering user interface of the present invention.

FIG. 9 illustrates a typical loan information gathering user interface of the present invention.

FIG. 9A illustrates a typical NSLDS loan information screen of the prior art.

FIG. 10 illustrates a typical loan information gathering user interface with loan data pasted of the present invention.

FIG. 11 illustrates a typical loan detail information gathering user interface of the present invention.

FIG. 11A illustrates a typical NSLDS loan detail information screen of the prior art.

FIG. 12 illustrates a typical loan detail information gathering user interface with loan detail data pasted of the present invention.

FIG. 13 illustrates a typical loan detail information gathering user interface with the loan detail data processed of the present invention.

FIG. 14 illustrates a typical signature user interface of the present invention.

FIG. 15 illustrates a typical summary information user interface of the present invention.

FIG. 16 illustrates a flow chart of the present invention.

FIG. 17 illustrates a second flow chart of the present invention.

FIG. 18 illustrates an exemplary loan data screen.

FIG. 19 illustrates an exemplary loan data screen with an account number highlighted.

FIG. 20 illustrates a simplified exemplary loan data entry screen.

FIG. 21 illustrates a simplified exemplary loan data entry screen with the account number pasted into the appropriate field.

FIG. 22 illustrates a simplified exemplary loan data entry screen with the entire window highlighted.

FIG. 23 illustrates a second simplified exemplary loan data entry screen.

FIG. 24 illustrates the simplified exemplary loan data entry screen with the highlighted data from FIG. 22 pasted into a text box.

FIG. 25 illustrates the simplified exemplary loan data entry screen after the highlighted data is processed.

FIG. 26 illustrates a typical computer system used by the present invention.

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures. The description used to describe the operation of the present invention relates to a web-based loan consolidation service. In this, a user must provide data regarding all of their current student loans into the loan consolidation application screens. The present invention provides methods and apparatus to greatly increase the efficiency of a user in providing this information. The present invention is not limited to a loan consolidation or a loan origination application. The present invention applies to any situation in which a user needs to copy data segments from one application to input fields (or similar) of another application.

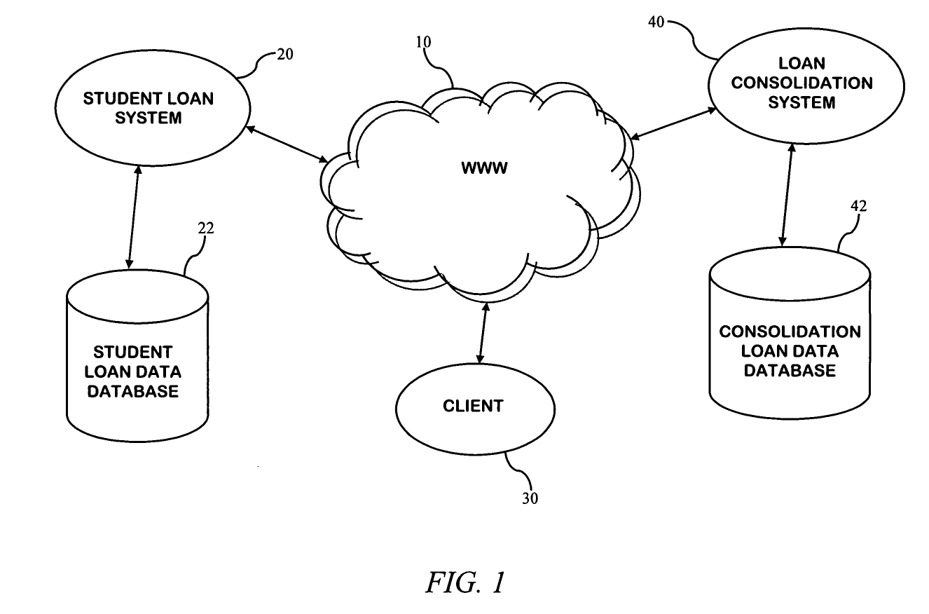

Referring to FIG. 1, a block diagram of a system of the present invention is shown. In many software environments, the copy and paste function (sometimes referred to as cut and paste) saves users untold amounts of time, precluding the need to retype what is already displayed on their computer monitor. In some examples, local data is highlighted as known in the industry, copied (which copies the data onto what is known as the “clipboard”), and pasted. For example, if a user has an existing document that has a paragraph that they wish to include in a new document, the user opens both documents, highlights the paragraph they wish to copy and initiates the copy function, perhaps by using the shortcut of holding the control key and pressing the ‘C’ key (ctrl-c). Now the paragraph is copied onto the clipboard. The user now switches to the new document, positions the cursor where they want to insert the paragraph and initiates the paste function, perhaps using the shortcut of holding the control key and pressing the ‘V’ key. The paragraph is now inserted into the new document.

Another use of cut/copy and paste is to highlight text (and images) from a page of the Internet and pasting the text into a local document. Of particular interest to the present invention is cutting data from a page of the internet and pasting those text/images into another page of the internet. Presently, a user is able to copy from one internet page and paste into another. For example, if the user wants to accurately copy a long number from a display page on the internet into a data entry page on the internet, the copy and paste function works well. The copy function requires that the user highlight exactly the text they want to copy, perhaps using their mouse to highlight the text. This leads to the possibility of error, perhaps from highlighting less than the full data needed or highlighting more data than necessary.

To show this, consider a loan consolidation application where a user has multiple existing loans (e.g., student loans) and needs to copy data from each of these loans into a consolidation data entry page of a loan application. The user has access to a student loan system 20 such as the National Student Loan Data Service (NSLDS) provided by the United States Department of Education. At this site, the user (e.g., borrower) us provided screens (e.g., web pages) to review their existing loans, make payments, etc. The student loan system 20 has a database 22 for storing this information. The user accesses this data through the internet 10 from a client computer 30. Now, the user wants to apply for a consolidated loan, combining all of their existing loans into one master loan, perhaps with a better interest rate or payment terms. To do so, the user accesses the loan consolidation server 40 and copies data from each of the multiple loans onto data entry pages of the loan consolidation system 40 and, eventually, the data are stored in a consolidation loan database 42. Because the required data is stored in multiple fields in the student loan system 20, prior to the present invention, the user had to either retype the information or repeatedly copy and paste from the student loan display pages into the consolidation pages. The present invention greatly reduces the number of copy and paste operations, thereby reducing the chance of error while improving the user interface and customer satisfaction.

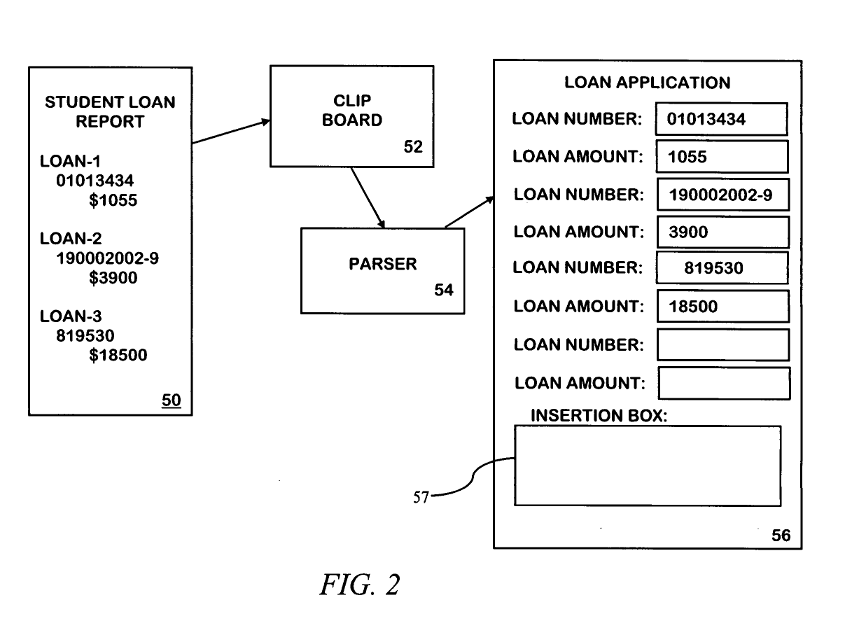

Referring to FIG. 2, a block diagram showing an example data flow of the present invention is shown. In this example, a typical student loan report 50 is a summary report showing three loans (loan-1, loan-2 and loan-3). With the present invention, the entire loan summary page 50 is copied (copied to the clip board 52) as known in the industry. When the data is pasted from the clip board 52 onto the loan application summary page 56, the data passes through a parser 54 that checks to make sure the user copied valid information and then parses the information into independent data the corresponds to the data entry fields of the loan application input user interface 56. The independent data from the parser is then pasted into each independent field of the loan application form 56. With this, the user only need copy the entire page from the student loan report 50 using ctrl-a (highlight everything on the page), ctrl-c (copy the entire page including white space and graphics) then select the data entry box 57 on the loan application 56 and paste the entire page using ctrl-v (any other copy and paste commands are also anticipated). The parser 54 removes all of the unneeded information, storing only the required loan information in the target fields of the loan application 56.

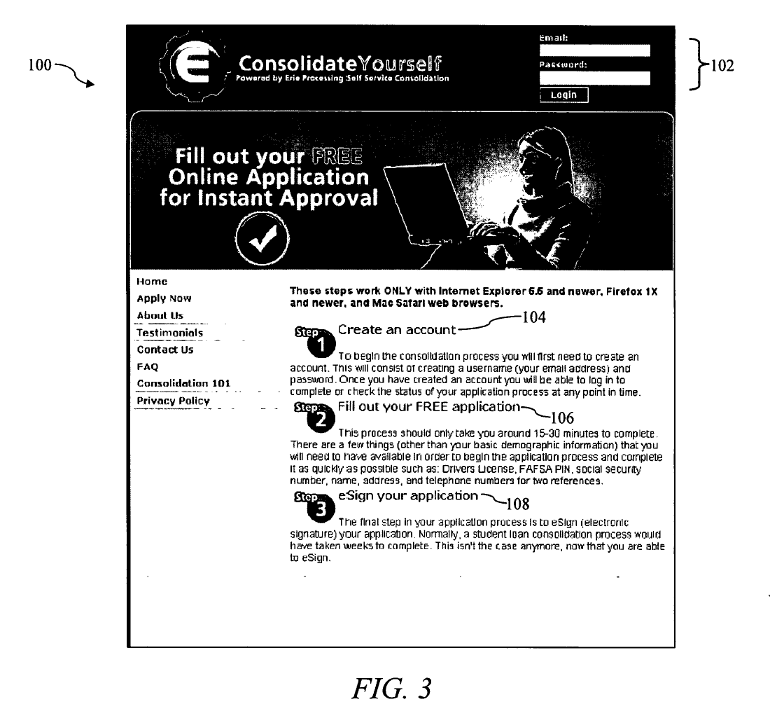

Referring to FIG. 3, a typical loan consolidation user interface of the present invention is shown. In this example, the loan consolidation user interface 100 provides a facility for a returning user to login 102 and links for a user to create an account 104, complete an application 106 and sign a completed application 108. In some embodiments, other features are available on the various user interface pages as known in the industry.

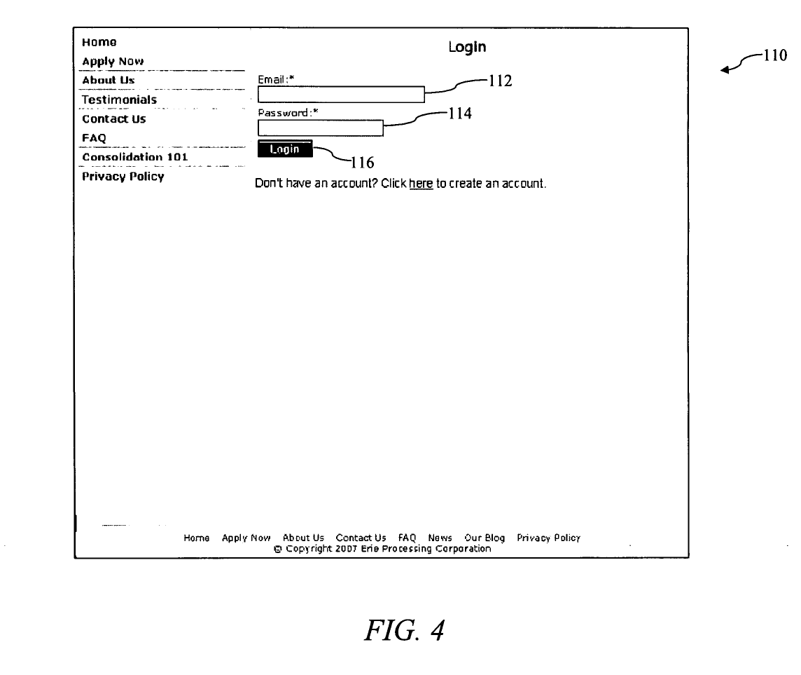

Referring to FIG. 4, a typical login user interface of the present invention is shown. This exemplary login user interface 110 requests a user name 112 (email address in this example) and password 114. After the user enters their credentials, they select the “login” icon 116 and their credentials are checked as known in the industry, and if correct, access to subsequent user interface screens is provided.

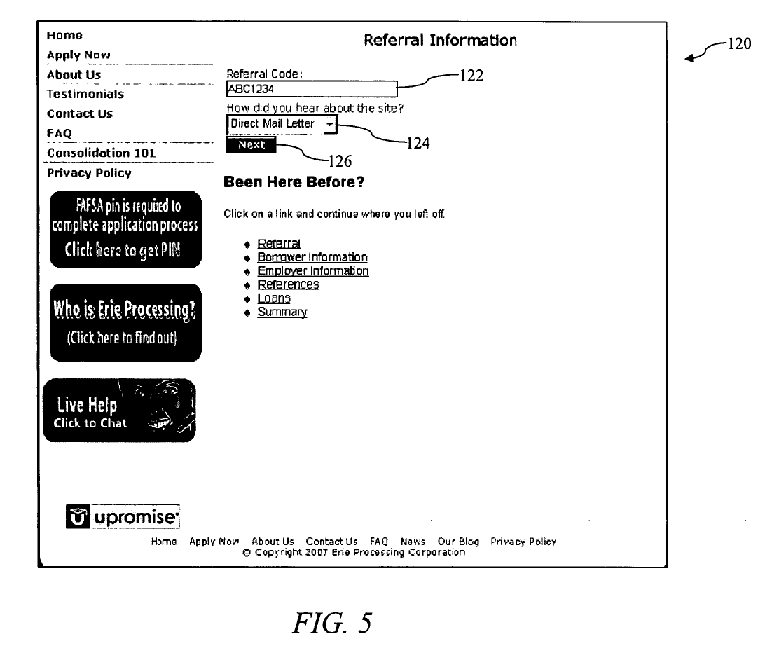

Referring to FIG. 5, a typical information gathering user interface of the present invention is shown. In this information gathering user interface 120, the user is prompted to enter a referral code 122 and select how they heard about the site 124 before selecting the “next” icon 126. This is an example and in other embodiments, information gathering is not used or other information is requested.

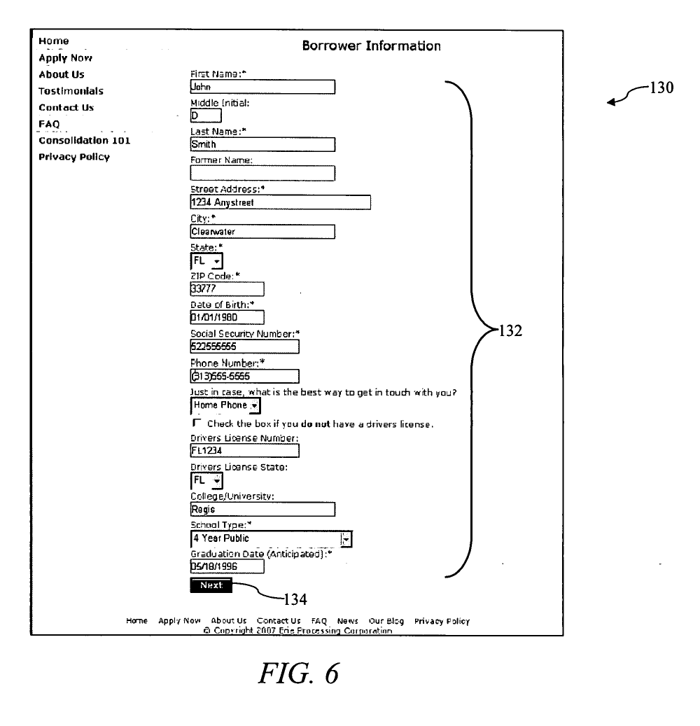

Referring to FIG. 6, a typical borrower information gathering user interface of the present invention is shown. In the borrower information gathering user interface 130, the user enters various information 132 regarding the borrower, for example, their name, address, social security number, graduation date, etc. Once complete, the user selects the “next” icon 134 to proceed.

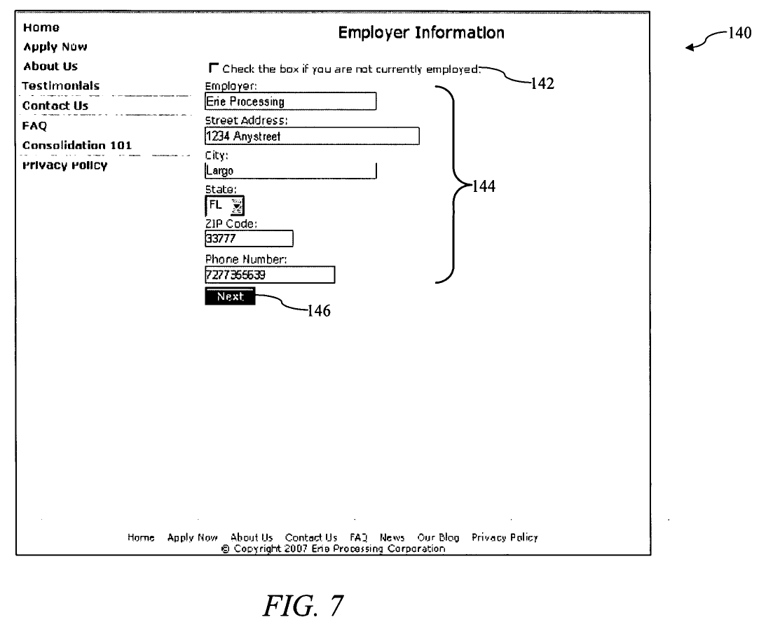

Referring to FIG. 7, a typical employer information gathering user interface of the present invention is shown. The employer user interface 140 is provided in some embodiments to collect employment information 144 relating to the borrower such as company name and address. If the borrower is not employed, they select a check box 142 indicating such before selecting the “next” icon 146 and proceeding to the next user interface page. In some embodiments, more or less employment information is collected.

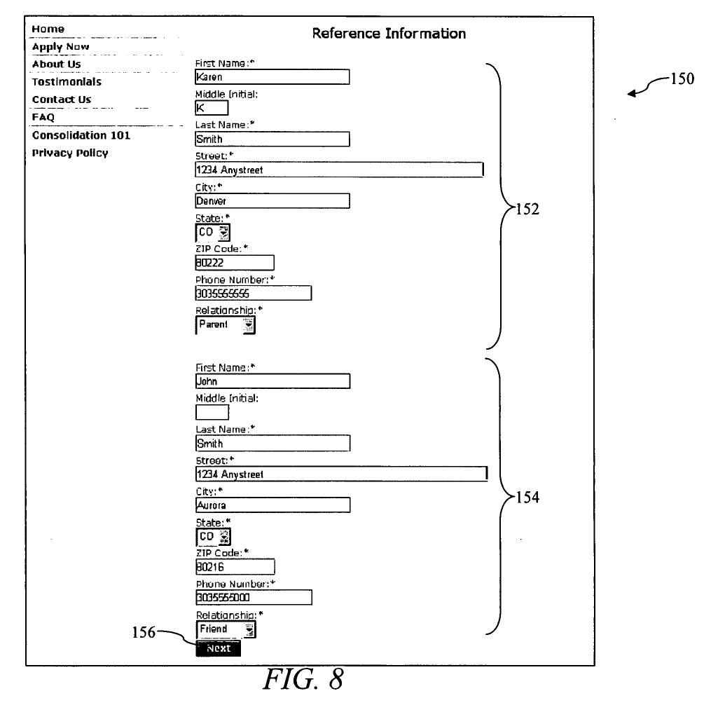

Referring to FIG. 8, a typical references gathering user interface of the present invention is shown. In this typical references gathering user interface 150, the user enters contact information for two references 152/154 who know the borrower. Once completed, the user selects the “next” icon 156 to proceed to the next user interface page. In some embodiments, more or less reference information is collected.

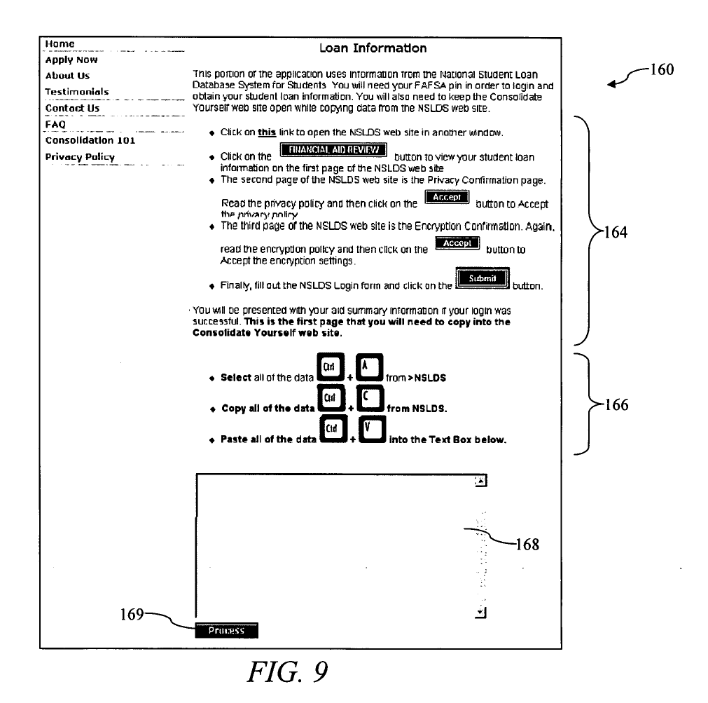

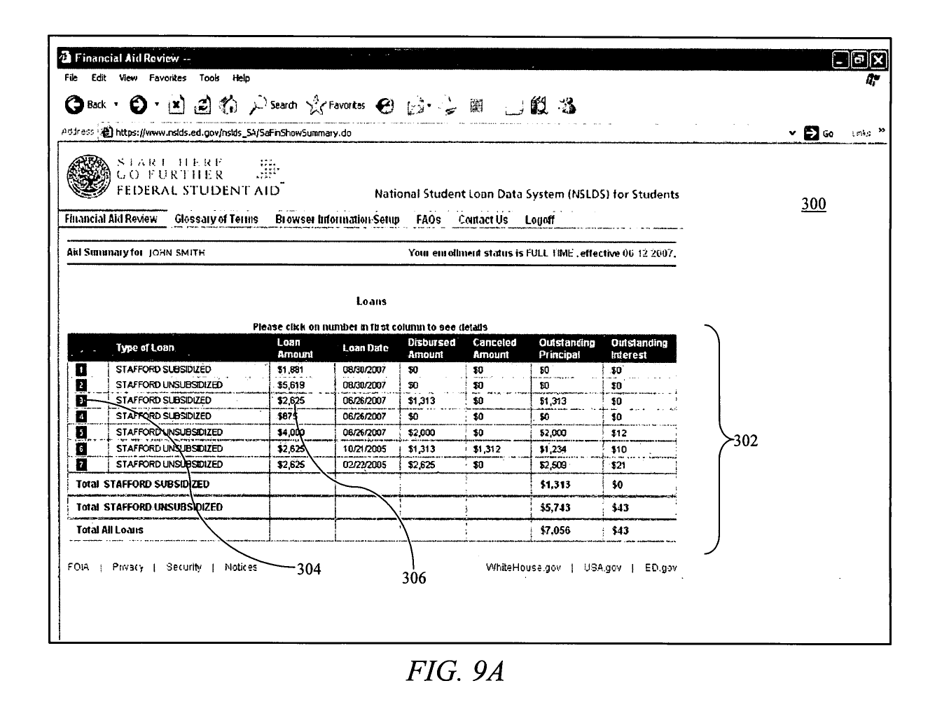

Referring to FIG. 9, a typical loan information gathering user interface of the present invention is shown. The loan information gathering user interface 160 gathers summary information regarding all of the loans the borrower has. Instead of requiring the user to copy/paste (or type) information regarding each of their current loans into individual fields, the present invention provides detail, step-by-step directions 164 on how to open the NSLDS web site to view their summary loan information and detail instructions 166 regarding how to copy all of the data from the NSLDS loan summary page 300 (see FIG. 9A) (using ctrl-a, ctrl-c) then pasting the data into the text box 168 (using ctrl-v). The “process” function 169 is discussed later.

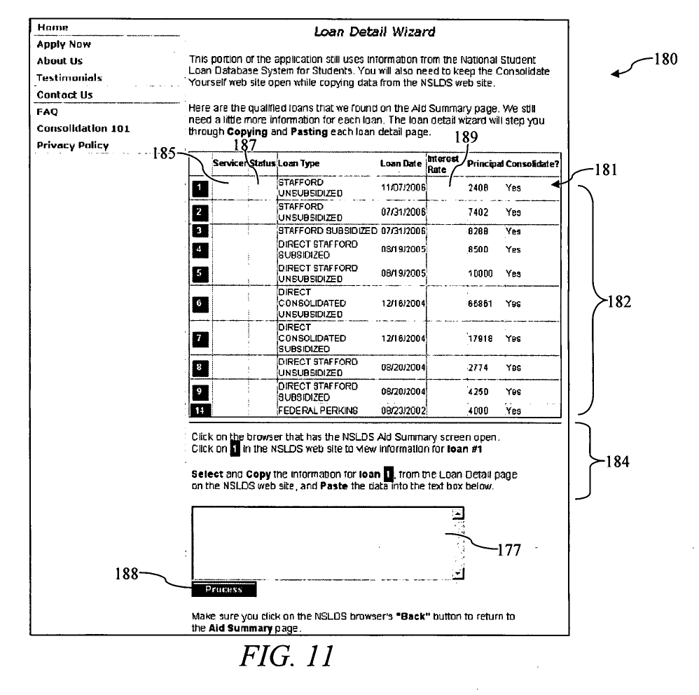

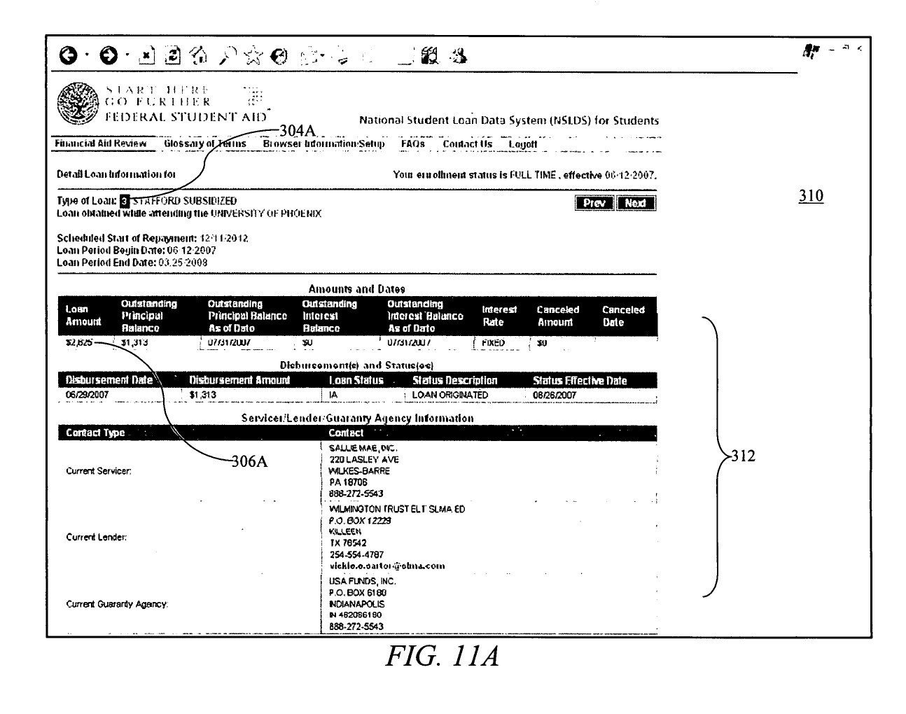

Referring to FIG. 9A, a typical NSLDS loan information screen of the prior art is shown. This screen is typical of the National Student Loan Data Service, operated by the United States Department of Education. The loan information screen 300 contains information regarding all student loans for which the user is accountable in the “Loans” area 302. Note, the third loan 304 is in the amount of $2625 306. Details of this loan are shown in FIG. 11A.

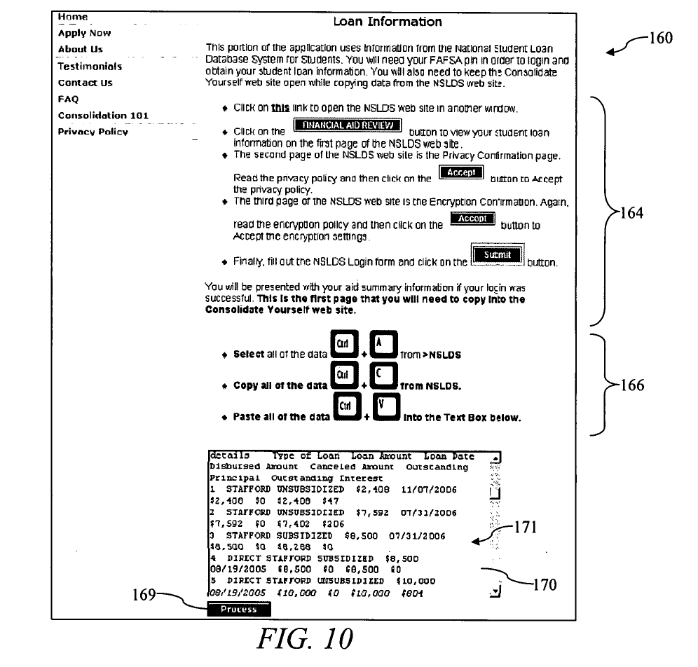

Referring to FIG. 10, a typical loan information gathering user interface with loan data pasted of the present invention is shown. This view of the loan information gathering user interface 160 shows the text box 170 filled in with data copied from the NSLDS loan summary page 300. As shown, the individual loan data is shown along with other text from the NSLDS loan summary page. For example, two lines 171 include detail information regarding a Stafford loan of $2,565. Now that the NSLDS loan summary data is copied into the text box 170, the user selects the “process” icon 169 to process the loan summary data.

Referring to FIG. 11, a typical loan detail information gathering user interface of the present invention is shown. The typical loan detail information gathering user interface 180 has been populated with the detailed loan data that was previously pasted into the text box 170. The parser 54 has processed the loan summary data from the text box 170 into individual loan summary fields (target fields). For example, the two lines 171 regarding the Stafford loan of $2565 were parsed and copied into individual fields relating to loan-1 181. Multiple open loans appear in separate rows 182 of the loan detail information gathering user interface 180. Note that certain columns have no information such as Service Provider 185, Status 187 and Interest Rate 189. This is because this information is not available on the student loan summary information page from the NSLDS. To obtain this information that is required to complete the consolidate loan application, the user is instructed 184 to select each loan (starting with loan-1) on the NSLDS site, opening a detail page for each loan 310 (see FIG. 11A), and while at each detail page, copying the entire page (ctrl-a, ctrl-c) then pasting (ctrl-v) the entire page into the detail text box 177. The “process” 188 function is described later.

Referring to FIG. 11A, a typical NSLDS loan detail information screen of the prior art is shown. This particular NSLDS detail loan page 310 is for loan-3. It identifies the loan sequence number of 3 304 and the loan amount of $2,625 306. The detail information area 312 contains various details; some needed to complete the consolidation application and others not needed.

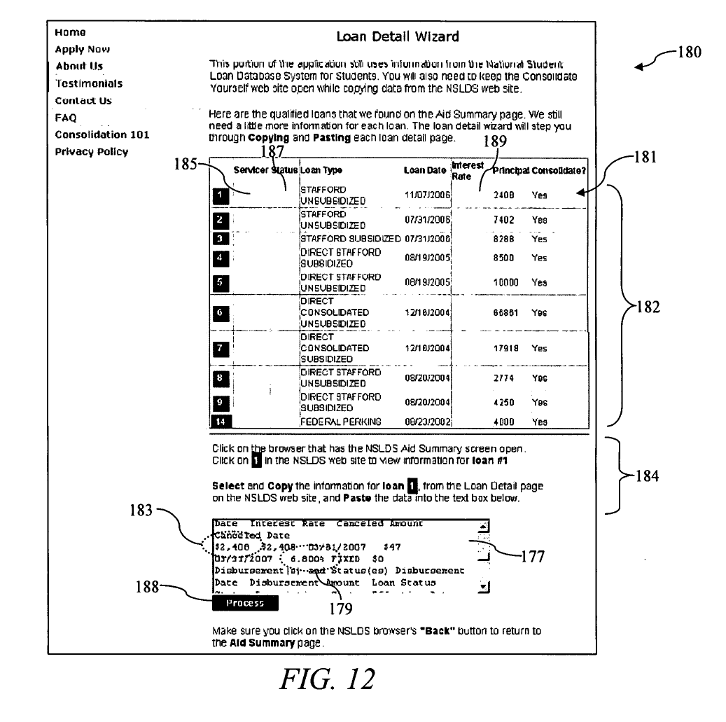

Referring to FIG. 12, a typical loan detail information gathering user interface with loan detail data pasted of the present invention is shown. The loan detail user interface 180 is now shown with the detailed loan information for loan-1 pasted in the detail text box 177. This loan detail information includes information similar to that on the loan summary screen 300 such as the loan amount of $2,408 183 plus other information that is needed but not present on the loan summary screen 300 such as the interest rate of 6.800% 179. After pasting the data into the detail text box 177, the user selects the “process” icon 188 to process the data.

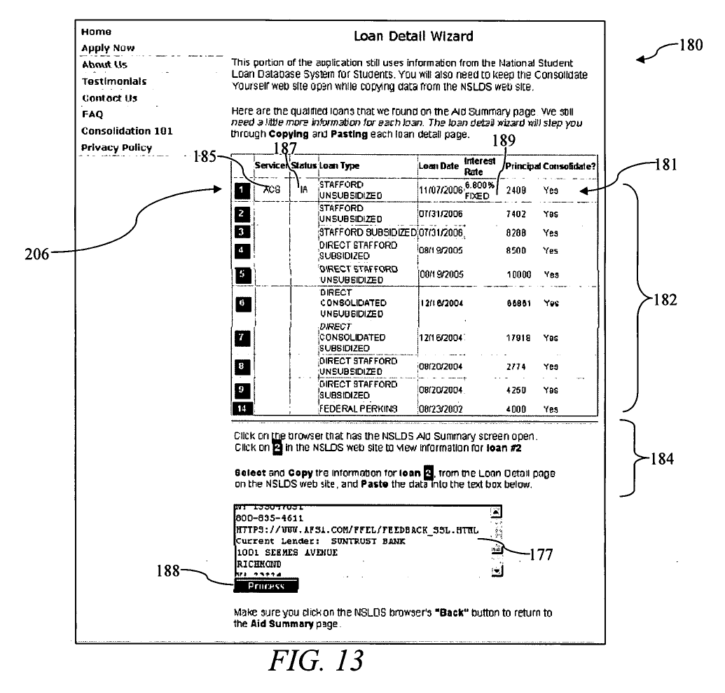

Referring to FIG. 13, a typical loan detail information gathering user interface 180 with the loan detail data processed of the present invention is shown. Once pasted, the user selects the “process” icon 188 and the parser 54 checks the data in the detail text box 177 to make sure the user pasted proper information (e.g., makes sure the loan number is loan-1). Now the data from the detail text box 177 is parsed by the parser 54 to extract the Service 185, Status 187 and Interest Rate 189 data and this data is pasted into the corresponding target fields of the column related to the first loan 181. The detail loan data copy steps 184 are then repeated for each active loan until the entire loan detail information user interface 180 is populated with detail loan information.

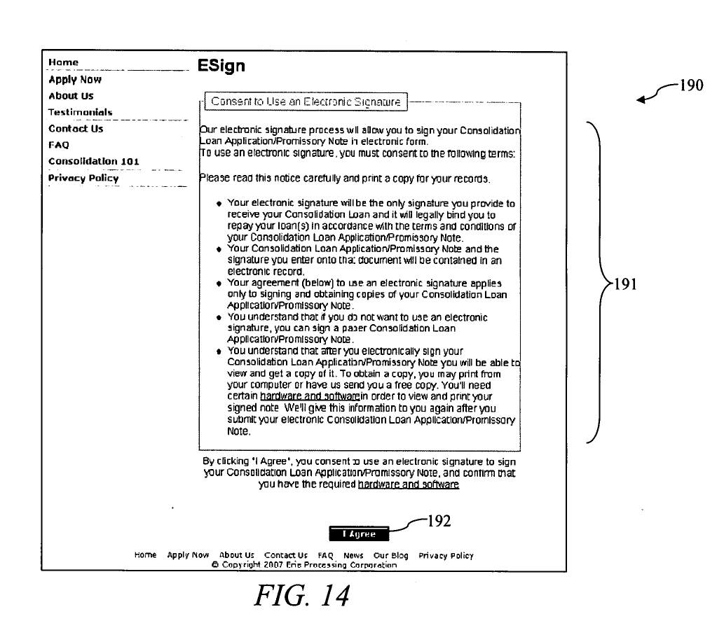

Referring to FIG. 14, a typical signature user interface of the present invention is shown. In the signature user interface 190, the signature process is described 191 and if the user agrees, the user selects the “I agree” icon 192 to concur and sign their application. In other embodiments, no signature is required or other forms of signature capture are provided as known in the industry.

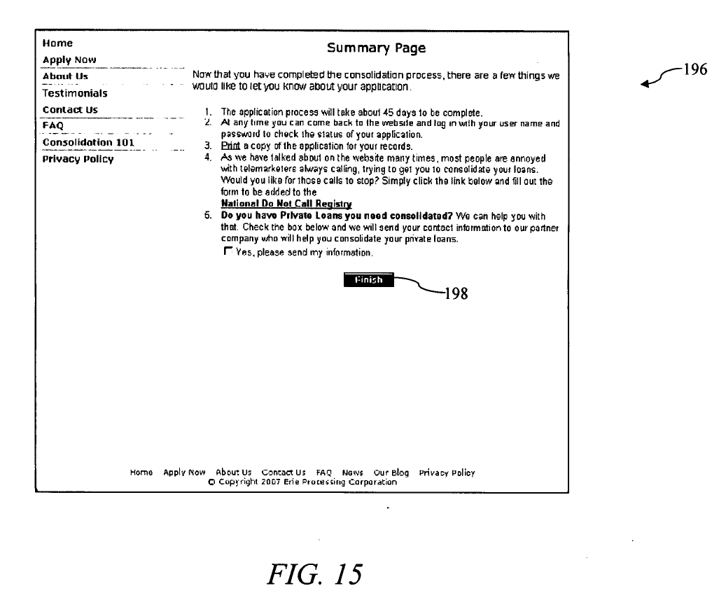

Referring to FIG. 15, a typical summary information user interface of the present invention is shown. The summary information user interface 196 summarizes the next steps in the loan process. Once finished reading this page, the user selects the “finish” icon 198 to finish the entire process. In some embodiments, other user interfaces are presented as known in the industry.

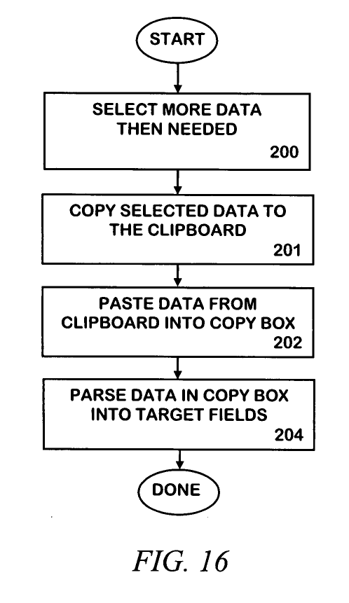

Referring to FIG. 16, a flow chart of the present invention is shown. The flow starts when data is copied to the clip board 200. Prior to the present invention, a selection of data was copied to the clip board. For example, if a user needs to supply an account number to a data entry screen and this account number is visible in a different window, the user highlights the account number in that window, views the data entry screen (e.g., switches context to the data entry screen), selects the location where the account number is to go and pastes (ctrl-v) the account number into that location. Referring to FIG. 16, using methods of the present invention, the user highlights a section of the source window 200. This selection is, in some embodiments, the entire source window. In other embodiments, it is a section, paragraph, etc. The user then copies the highlighted data to the clipboard 201 using the copy function (e.g., ctrl-c). The user then pastes the highlighted data from the clipboard to the insertion box or copy box 202. When the user selects “process”, the parser parses the copied data into the appropriate target fields 204.

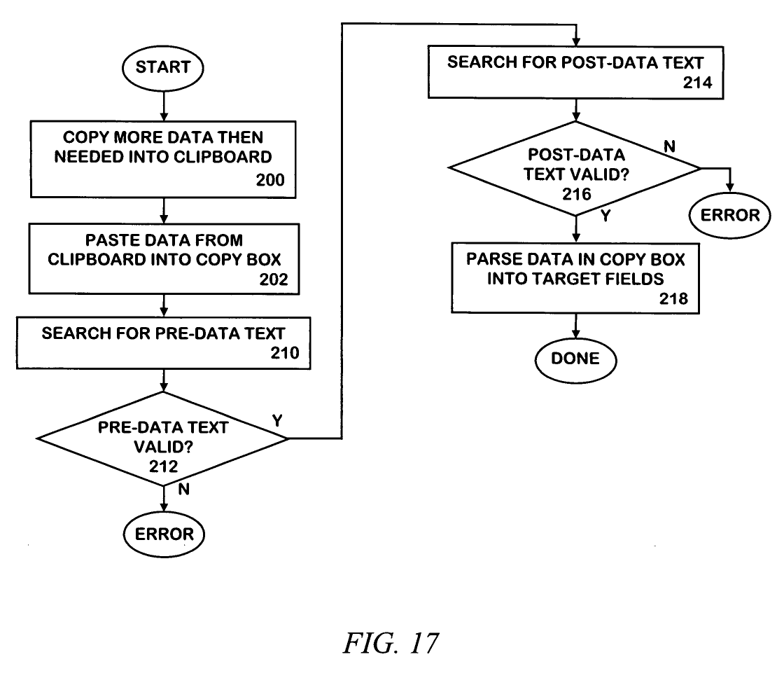

Referring to FIG. 17, a second flow chart of the present invention is shown. In this example, the data is copied onto the clipboard 200 and pasted into the copy box 202 as in FIG. 16. In the example of FIG. 17, a search of the data in the copy box 202 is made to find preamble text 210 that assures the user is on the appropriate NSLDS screen. For example, the text string “Aid Summary for:” should appear in the text box (see FIG. 9A). If the pre-data text is not valid 212, an error is reported (e.g., the user is instructed to copy data from the correct page). If the pre-data text is valid 212, in some embodiments, a search is made for post-data text 214 such as “WhiteHouse.gov (see FIG. 9A). If the post-data text is found and valid 216, the data in the copy block is parsed and the appropriate data elements stored in the target fields 218. If the post-data text is not valid 216, an error is reported (e.g., the user is instructed to copy data from the correct page). Using both the pre-text test and the post-text test provides a level of assurance that the user correctly copied the correct page and the appropriate amount of information from that page.

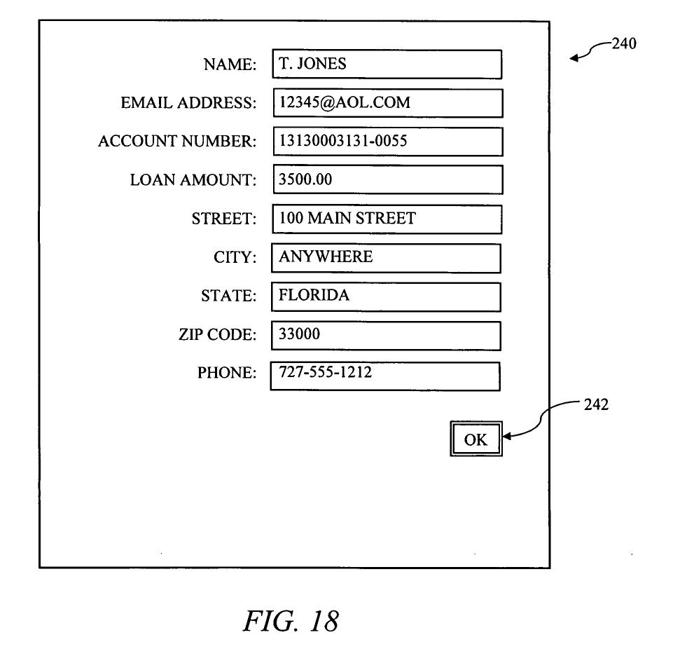

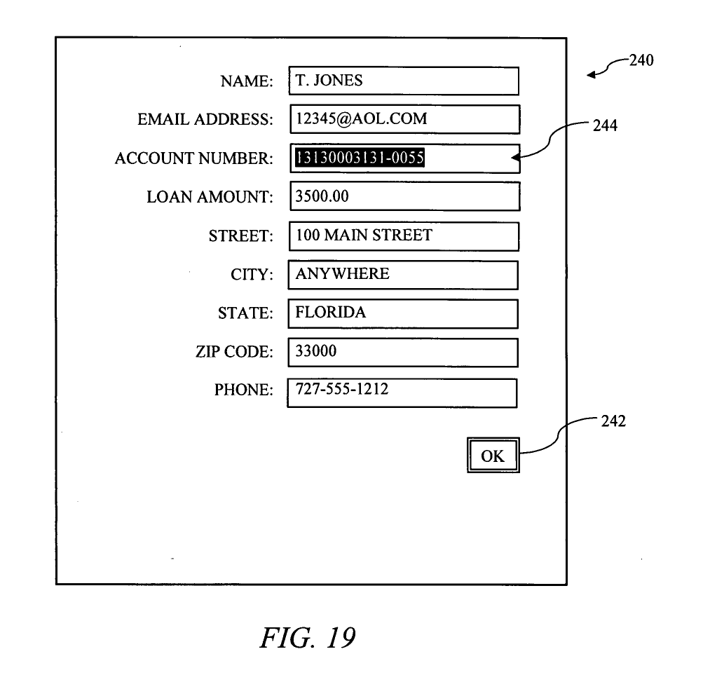

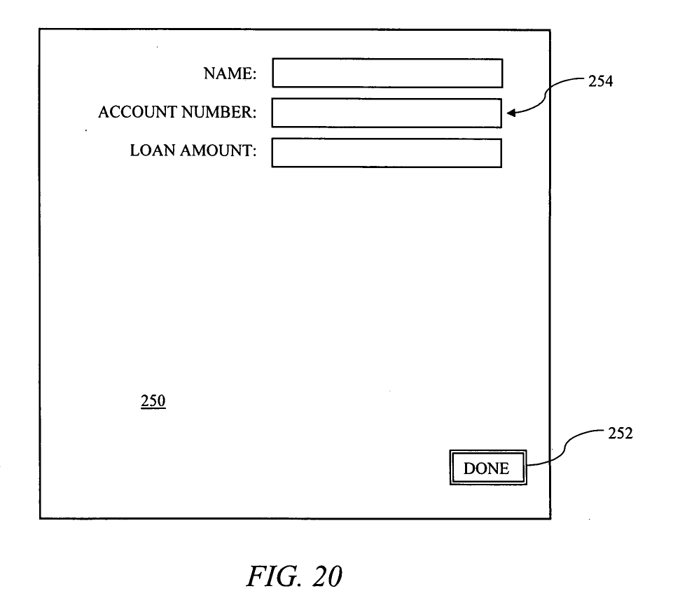

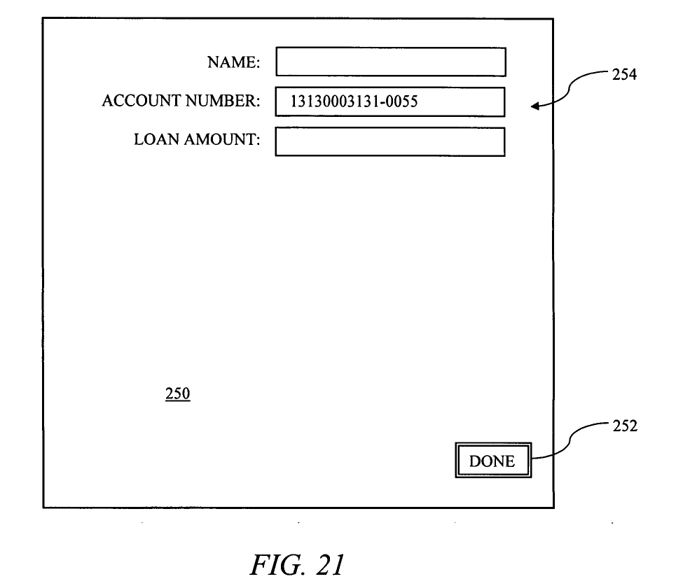

Referring to FIGS. 18-21, the process of copying information from a loan data screen to a loan application screen of the prior art will be described. An exemplary loan data screen 240 is shown in FIG. 18. It has data regarding a single existing loan and an “OK” selection icon for proceeding to the next screen, etc. To originate a new loan, the user needs to copy certain data from this screen 240 to the loan application screen 250 (FIGS. 20-21). Prior to the present invention, the user needed to highlight each data from the loan data screen 240. As an example in FIG. 19, the account number 244 is highlighted; then the highlighted data is copied (onto the clipboard); then the loan application screen 250 is viewed; then the destination for the account number 254 (FIG. 20) is selected; and the account number 244 is pasted into the destination cell 254 (FIG. 21). These steps need to be repeated for each data that was needed for the loan application. The “OK” icon 242 is used in navigation.

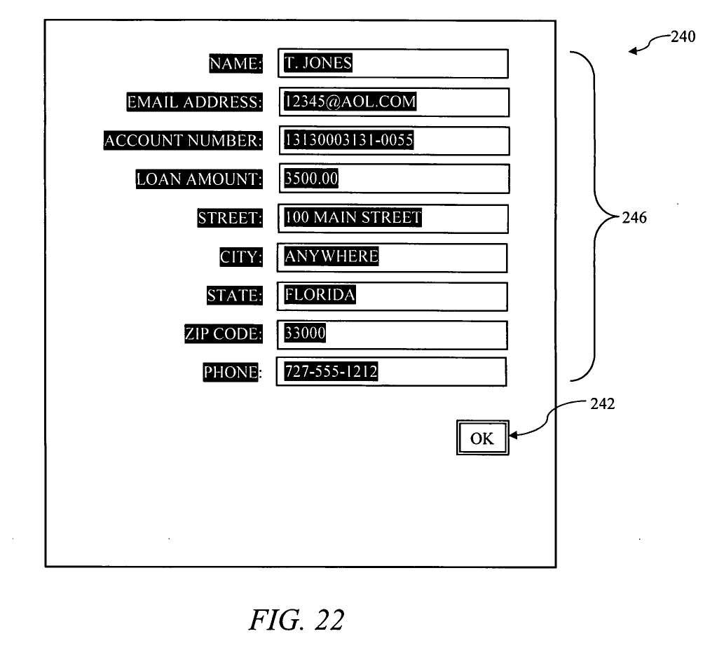

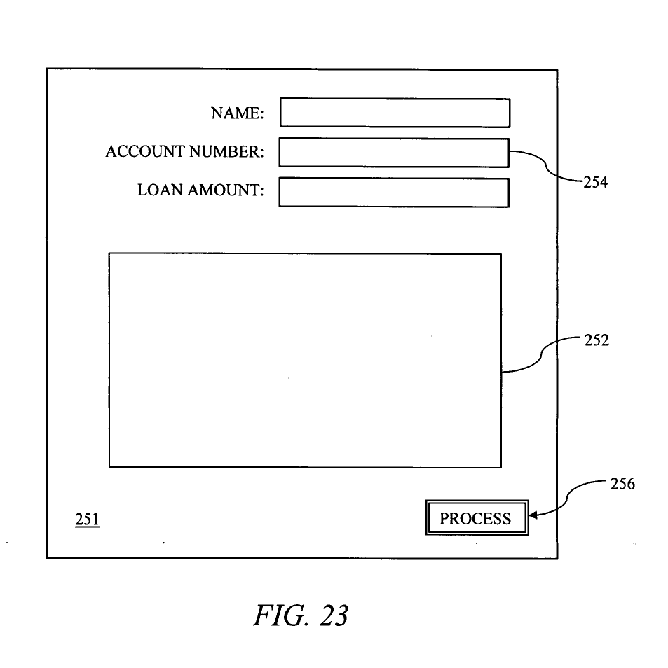

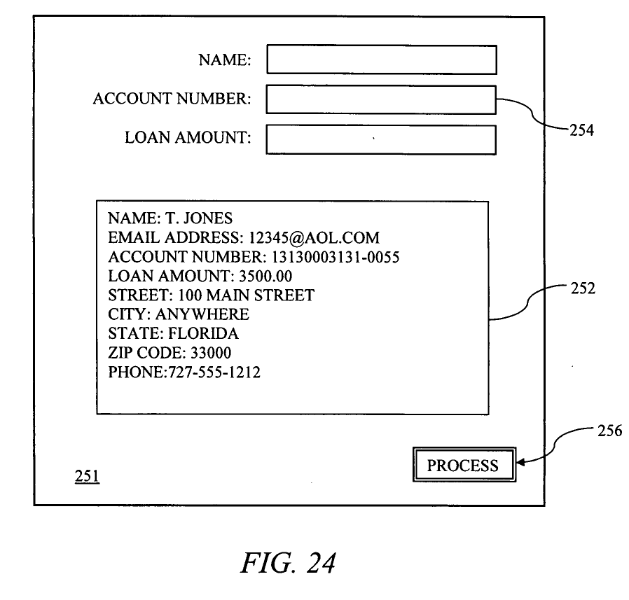

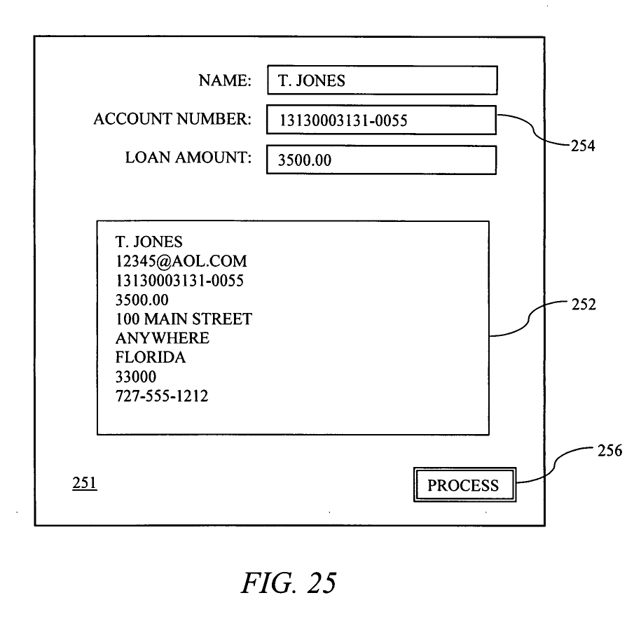

Referring to FIGS. 22-25, the process of copying information from a loan data screen to a loan application screen of the present invention will be described. In FIG. 22, the user has highlighted 246 the entire loan data screen 240. In this simplified example, all of the field names and data values 246 are highlighted. As per the described methods, after highlighting the entire page (e.g., using the ctrl-a) the user copies the entire page onto the clipboard (e.g., using ctrl-v). Next, the user navigates to the destination page which, in this example, is a simplified loan application data entry page 251 and selects (clicks on) the insertion box 252 (as in FIG. 23) then pastes the copied page from the clipboard into the insertion box 252, placing the copied data into the insertion box 252 (as shown in FIG. 24). When the user selects (clicks on) the “process” icon 256 (or equivalent), the parser 54 process the data as described previously and places the individual data item into the target fields (as in FIG. 25). For example, the account number is now in the account number target field 254 of the loan application data entry page 251. Note that with one copy/paste operation, all needed data is copied from the loan data screen 240 into the target field locations of the loan application data entry page 251. In most web applications, other types of data such as icons and images are highlighted as well and copied into the insertion box along with the field names and data values.

The parsers uses techniques known in the industry to find the needed data items, cut them out of the insertion box 252, and insert each data item in its target location 254. For example, the parser 54 found the account number in the insertion box and inserted it in the account number field 254. In this example, a simple parser would search for the string “Account Number:” in the insertion box 252, then copy the characters following the space up to the end of line character into the target location 254. As an example, a code segment of the parser may be:

```
char sstring[ ] = “Account Number:”;
char *p, *q;
char *d;
p = insertion_box;
d = &target_location;
while(*p != ‘\0’){
    if(*p == sstring[0]){
        q = sstring;
        while(*q != ‘\0’){
            if(*p != *q){
                break;
            }
            ++p;
            ++q;
        }
        //if end of sstring
        if(*q == ‘\0’){
        //p points to first char of acct
        while(*p != ‘\n’){
            //copy the acct# to the target loc
            *d++ = *p++;
        }
    }else{
        // error - “Account Number: ” not found
    }
}
```

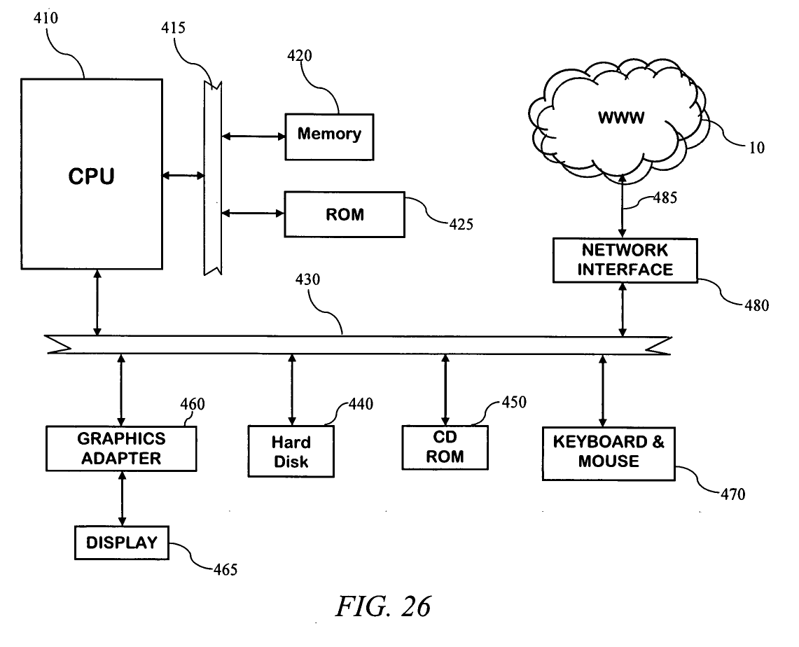

Referring to FIG. 26, a schematic diagram of a computer system of all embodiments of the present invention will be described. Although shown in its simplest form, having a single processor, many different computer architectures are known that accomplish similar results in a similar fashion and the present invention is not limited in any way to any particular computer system. The present invention works well utilizing a single processor system as shown in FIG. 26, a multiple processor system where multiple processors share resources such as memory and storage, a multiple server system where several independent servers operate in parallel (perhaps having shared access to the data or any combination. In the example shown, a processor 410 is provided to execute stored programs that are generally stored for execution within a memory 420. The processor 410 can be any processor or a group of processors, for example an Intel Pentium-4® CPU or the like. The memory 420 is connected to the processor through a memory bus 415. The memory 420 is any memory suitable for connection with the selected processor 410, such as SRAM, DRAM, SDRAM, RDRAM, DDR, DDR-2, etc. Firmware is stored in firmware storage 425 that is connected to the processor 410, also through the memory bus 415 and may include initialization software known as BIOS.

Also connected to the processor 410 is a system bus 430 for connecting to peripheral subsystems such as a network interface 480, a hard disk 440, a CDROM 450, a graphics adapter 460 and a keyboard/mouse 470. The graphics adapter 460 receives commands and display information from the system bus 430 and generates a display image that is displayed on the display 465.

In general, the hard disk 440 may be used to store programs, executable code and data persistently, while the CDROM 450 may be used to load said programs, executable code and data from removable media onto the hard disk 440. These peripherals are meant to be examples of input/output devices, persistent storage and removable media storage. Other examples of persistent storage include core memory, FRAM, flash memory, etc. Other examples of removable media storage include CDRW, DVD, DVD writeable, compact flash, other removable flash media, floppy disk, ZIP®, etc. In some embodiments, other devices are connected to the system through the system bus 430 or with other input-output connections. Examples of these devices include printers; graphics tablets; joysticks; and communications adapters such as modems and Ethernet adapters.

The network interface 480 connects the computer-based system to the world-wide-web 10 through a link 485 which is, preferably, a high speed link such as a cable broadband connection, a Digital Subscriber Loop (DSL) broadband connection, a T1 line or a T3 line.

Equivalent elements can be substituted for the ones set forth above such that they perform in substantially the same manner in substantially the same way for achieving substantially the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A method of copy and paste of multiple fields concurrently, the method comprising:
copying a plurality of fields onto a clipboard;
pasting the plurality of fields from the clipboard into an insertion box of a data input screen, the data input screen also having a plurality of target data fields;
parsing the plurality of fields from the insertion box into individual data segments; and
populating the target data fields with the individual data segments.

2. The method of copy and paste of multiple fields concurrently of claim 1, wherein the step of copying uses a shortcut key of ctrl-a to highlight the plurality of fields and uses a shortcut key of ctrl-c to copy the plurality of fields onto the clipboard.

3. The method of copy and paste of multiple fields concurrently of claim 1, wherein the step of pasting uses a shortcut key of ctrl-v to paste the plurality of fields from the clipboard into the insertion box of the data input screen.

4. The method of copy and paste of multiple fields concurrently of claim 1, wherein the step of parsing further includes the step of checking for pre-text data in the plurality of fields.

5. The method of copy and paste of multiple fields concurrently of claim 5, wherein the step of parsing further includes the step of checking for post-text data in the plurality of fields.

6. A system copying and pasting of multiple fields concurrently, the system comprising:
a server computer;
a data entry screen presented by the server to a user; the data entry screen having at least one insertion box for accepting data from a clip board, the data entry screen also comprising a plurality of target data fields; and
a parser adapted to parse data from the data entry screen into individual field values and the parser adapted to populate the target data fields with the individual field values;
whereas the data is pasted into the at least one insertion box and the data includes more information than the plurality of target data fields.

7. The system copying and pasting of multiple fields concurrently of claim 6, wherein the data includes data from an entire web page.

8. The system copying and pasting of multiple fields concurrently of claim 7, wherein the data is obtained from the web page using a highlight-all and copy commands.

9. The system copying and pasting of multiple fields concurrently of claim 5, wherein the parser also checks for pre-text data in the plurality of fields.

10. The system copying and pasting of multiple fields concurrently of claim 5, wherein the parser also checks for post-text data in the plurality of fields.

11. A signal tangibly embodied in a propagation medium comprising at least one instruction configured to implement a system copying and pasting of multiple fields concurrently, wherein the at least one instruction comprises:
computer readable instructions for presenting a data entry screen; the data entry screen having an insertion box for accepting data from a clip board, the one data entry screen also having a plurality of target data fields; and
computer readable instructions for parsing data from the data entry screen into individual field values; and
computer readable instructions for populating at the target data fields with the individual field values;
whereas the data is from a paste operation into the insertion box and the data includes more information than the plurality of target data fields.

12. The signal tangibly embodied in a propagation medium comprising at least one instruction configured to implement a system copying and pasting of multiple fields concurrently of claim 11, wherein the data is a copy of an entire web page.

13. The signal tangibly embodied in a propagation medium comprising at least one instruction configured to implement a system copying and pasting of multiple fields concurrently of claim 12, wherein the data is copied from the web page using a highlight-all and copy functions.

14. The signal tangibly embodied in a propagation medium comprising at least one instruction configured to implement a system copying and pasting of multiple fields concurrently of claim 13, wherein the order of the target data fields does not match the order of the data.

15. The signal tangibly embodied in a propagation medium comprising at least one instruction configured to implement a system copying and pasting of multiple fields concurrently of claim 14, wherein the computer readable instructions for parsing also includes computer readable instructions for checking for pre-text data in the data.

16. The signal tangibly embodied in a propagation medium comprising at least one instruction configured to implement a system copying and pasting of multiple fields concurrently of claim 15, wherein the computer readable instructions for parsing also includes computer readable instructions for checking for post-text data in the data.

17. A computer-based system for copying and pasting of multiple fields concurrently, the computer-based system comprising:
a first server computer;
a second server computer;
a client computer in network communications with the first server and with the second server, the client computer running software modules for accessing the first server and accessing the second server;
software modules running on the first server computer for presenting data;
software modules running on the second server for presenting a data input screen at the client computer;
software modules running on the client computer for copying the data onto a clipboard;
an insertion box on the data input screen;
a plurality of target data fields on the data input screen;
software modules running on the client computer for pasting the data from the clipboard into the insertion box on the data input screen;
software modules running on the second server computer for parsing the data from the insertion box into individual field values; and
software modules running on the second server computer for storing the individual field values in the target data fields,
whereas the data includes more information than needed in the target data fields.

18. The system for copying and pasting of multiple fields concurrently of claim 17, wherein the data is a copy of an entire web page.

19. The system for copying and pasting of multiple fields concurrently of claim 18, wherein the data is copied from the web page using a highlight-all and copy function.

20. The system for copying and pasting of multiple fields concurrently of claim 18, wherein the order of the target data fields does not match the order of the data.
